(19) United States
(12) Patent Application Publication
(10) Pub. No.: US 2008/0003415 A1
(43) Pub. Date: Jan. 3, 2008

(54) Surface Pairs

(76) Inventor: Avto Tavkhelidze, TBILISI (GE)

Correspondence Address: Borealis Technical Limited, 23545 N W Skyline Blvd, North Plains, OR, 97133-9205, US

(21) Appl. No.: 11/667,882

(22) PCT Filed: Nov. 17, 2005
(86) PCT No.: PCT/US05/42093

§ 371 Date: May 15, 2007

Related U.S. Application Data
(63) Continuation-in-part of application No. 10/508,914, filed on Sep. 22, 2004, now Pat. No. 7,074,498.
(60) Provisional application No. 60/366,563, filed on Mar. 22, 2002.
(60) Provisional application No. 60/366,564, filed on Mar. 22, 2002.
(60) Provisional application No. 60/373,508, filed on Apr. 17, 2002.

(30) Foreign Application Priority Data
Nov. 17, 2004 (GB) 042560.7

(51) Int. Cl. B32B 3/00; B05D 5/12

(52) U.S. Cl. 428/209; 427/123

(57) ABSTRACT

The present invention is a method for fabricating an electrode pair precursor which comprises the steps of creating on one surface of a substrate one or more indents of a depth less than approximately 100 nm and a width less than approximately 1 μm; depositing a layer of material on the top of this structured substrate to forming a first electrode precursor; depositing another layer the first electrode precursor to form a second electrode precursor; and finally forming a third layer on top of the second electrode precursor.

### CROSS-REFERENCE TO RELATED APPLICATIONS

This application is the U.S. national stage application of International Application No. PCT/US2005/042093, filed Nov. 17, 2005, which international application was published on May 26, 2006, as International Publication WO/2006/055890 in the English language. The International Application claims the benefit of UK Patent Application No. 0425260.7, filed Nov. 17, 2004. This application is a Continuation in part of U.S. patent application Ser. No. 10/991,257 filed Nov. 16, 2004, which is a continuation-in-part application of application Ser. No. 10/508,914 filed Sep. 22, 2004, which is a U.S. national stage application of International Application PCT/US03/08907, filed Mar. 24, 2003, which international application was published on Oct. 9, 2003, as International Publication WO03083177 in the English language. The International Application claims the benefit of U.S. Provisional Application No. 60/366,563, filed Mar. 22, 2002, U.S. Provisional Application No. 60/366,564, filed Mar. 22, 2002, and U.S. Provisional Application No. 60/373,508, filed Apr. 17, 2002. This application is also a continuation-in-part application of application Ser. No. 10/760,697 filed Jan. 19, 2004 which is a divisional application of application Ser. No. 09/634,615, filed Aug. 5, 2000, now U.S. Pat. No. 6,680,214, which claims the benefit of U.S. Provisional Application No. 60/149,805, filed on Aug. 18, 1999, and is a continuation application of application Ser. No. 09/093,652, filed Jun. 8, 1998, now abandoned, and is related to application Ser. No. 09/020,654, filed Feb. 9, 1998, now U.S. Pat. No. 6,281,514. The above-mentioned patent applications are assigned to the assignee of the present application and are herein incorporated in their entirety by reference.

### FIELD OF INVENTION

The present invention relates to methods for making electrode pairs in which the distribution of energy states within them is altered and for promoting the transfer of elementary particles across a potential energy barrier.

### BACKGROUND OF THE INVENTION

U.S. Pat. No. 6,281,514, U.S. Pat. No. 6,117,344, U.S. Pat. No. 6,531,703 and U.S. Pat. No. 6,495,843 disclose a method for promoting the passage of elementary particles at or through a potential barrier comprising providing a potential barrier having a geometrical shape for causing de Broglie interference between said elementary particles is disclosed. Also disclosed is an elementary particle-emitting surface having a series of indents. The depth of the indents is chosen so that the probability wave of the elementary particle reflected from the bottom of the indent interferes destructively with the probability wave of the elementary particle reflected from the surface. This results in the increase of tunnelling through the potential barrier. When the elementary particle is an electron, and potential barrier is surface of the substance electrons tunnel through the potential barrier, thereby leading to a reduction in the effective work function of the surface.

WO03083177 discloses modification of a metal surface with patterned indents that increases the Fermi energy level inside the metal, leading to a decrease in electron work function. Also disclosed is a method for making nanostructured surfaces having perpendicular features with sharp edges.

### DISCLOSURE OF INVENTION

The present invention is a method for fabricating an electrode pair precursor which comprises the steps of creating on one surface of a substrate one or more indents of a depth less than 10 nm and a width less than 1 μm; depositing a layer of material on the top of this structured substrate to forming a first electrode precursor; depositing another layer the first electrode precursor to form a second electrode precursor; and finally forming a third layer on top of the second electrode precursor.

In a further embodiment the method additionally comprises creating on the surface of the second electrode precursor one or more indents of a depth less than 10 nm and a width less than 1 μm.

In a further embodiment the method additionally comprises the deposition of a another layer between said first and second electrode precursor layers.

The present invention is also directed towards an electrode pair precursor comprising a substrate having on one surface one or more indents of a depth less than 10 nm and a width less than 1 μm; having a layer of material formed on the top of this structured substrate to form a first electrode precursor; having another layer formed on the first electrode precursor to form a second electrode precursor; and finally having a third layer formed on top of the second electrode precursor.

In a further embodiment the electrode pair precursor has on the surface of the second electrode precursor one or more indents of a depth less than 10 nm and a width less than 1 μm.

In a further embodiment the electrode pair precursor additionally comprises another layer between said first and second electrode precursor layers.

### BRIEF DESCRIPTION OF DRAWINGS

For a more complete explanation of the present invention and the technical advantages thereof, reference is now made to the following description and the accompanying drawing in which:

FIG. 1 shows the shape and dimensions of a surface structure utilised in the present invention;

FIGS. 2 and 3 show in a diagrammatic form processes for making the electrode pair precursors of the present invention;

FIGS. 4a and 4b show how the electrode pair precursors may be split to create electrode pairs;

FIGS. 4c and 4d show electrode pair precursors in which only one of the electrode precursors has a structured undersurface.

### BEST MODE FOR CARRYING OUT THE INVENTION

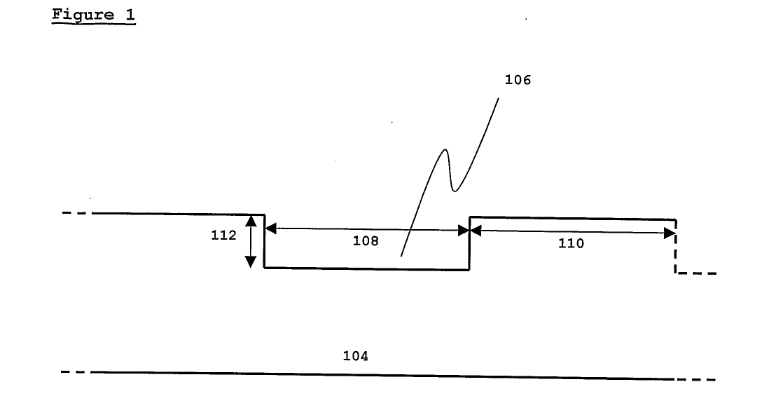

Embodiments of the present invention and their technical advantages may be better understood by referring to FIG. 1 which shows a substrate 104. The substrate has an indent 106 on one surface. Whilst the structure shown in FIG. 1 is a single indented region, this should not be considered to limit the scope of the invention, and dotted lines have been drawn to indicate that in further embodiments the structure shown may be extended in one or both directions (i.e. to the left and/or to the right) to form features on the surface of the substrate that have a repeating, or periodic, nature.

The configuration of the surface may resemble a corrugated pattern of squared-off, “u”-shaped ridges and/or valleys. Alternatively, the pattern may be a regular pattern of rectangular “plateaus” or “holes,” where the pattern resembles a checkerboard. The walls of said indents should be substantially perpendicular to one another, and the edges of the indents should be substantially sharp. Further, one of ordinary skill in the art will recognize that other configurations are possible which may produce the desired interference of wave probability functions. The surface configuration may be achieved using conventional approaches known in the art, including without limitation lithography and e-beam milling.

Indent 106 has a width 108 and a depth 112 and the separation between the indents is 110. Preferably distances 108 and 110 are substantially equal. Preferably distance 108 is of the order of 1 μm or less. Utilization of e-beam lithography to create structures of the kind shown in FIG. 1 may allow indents to be formed in which distance 108 is 100 nm or less. Distance 112 is of the order of 10 nm or less, and is preferably of the order of 5 nm.

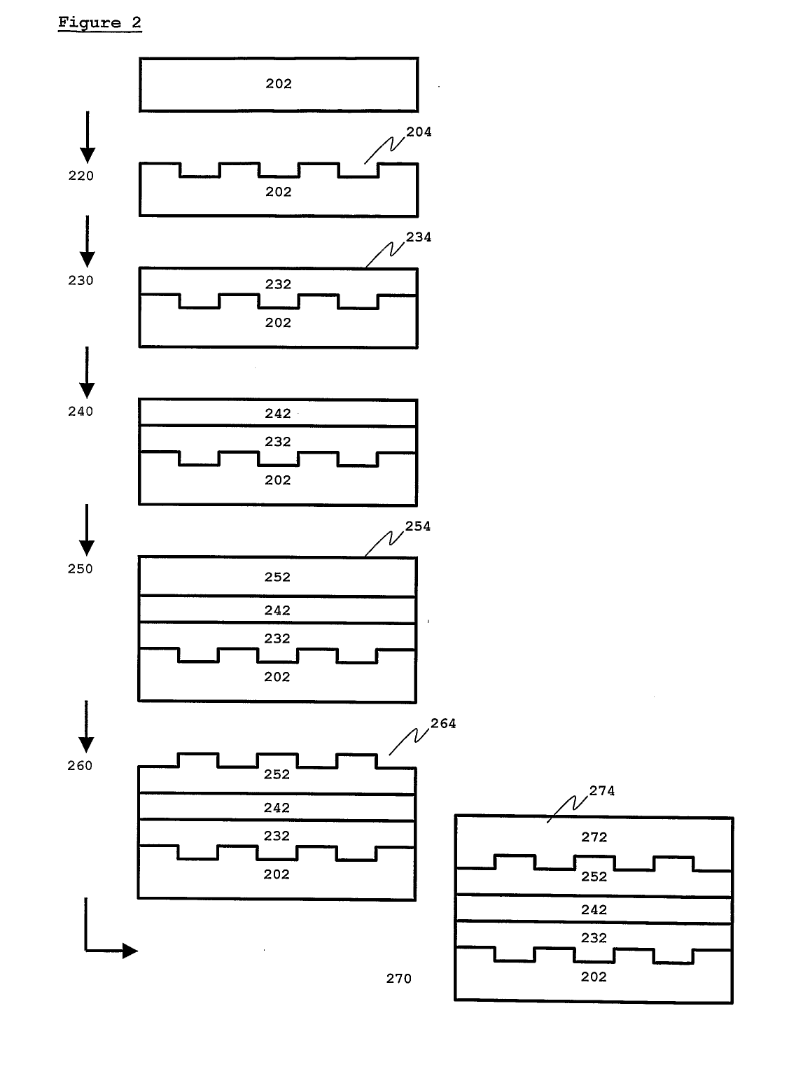

Referring now to FIG. 2, which shows in a diagrammatic form a process for making a pair of electrodes for use in a thermionic device, in a step 220 a surface of substrate 202 is modified to form a series of indents or channels 224 across the substrate. Substrate 202 may be for example and without limitation any substrate conventionally used in microelectronic or thermionic applications. Substrate 202 is preferably silica or silicon, which may optionally be doped to increase thermal or electrical conductivity. The indents or channels are formed for example and without limitation by any approach conventionally used in microelectronic applications, including stamping, milling, photolithography, e-beam lithography and ion-beam lithography. The dimensions of the indents are chosen to cause wave interference in a material, as disclosed above.

In a step 230, a layer of first material 232 is formed on the substrate in such a way that the indented regions are filled and so that the surface of the layer of a first material opposing said indented region 234 is substantially flat. Material 232 may be any material in which the Fermi level can be shifted using wave properties of electrons in material having a periodic structured surface. Preferably the material is one that, under stable conditions, will not form an oxide layer, or will form an oxide layer of a known and reliable thickness. Preferred materials include, but are not restricted to, metals such as gold and chrome, and materials that under stable conditions form an oxide layer preferably of less than about ten nanometers, and more preferably of less than about five nanometers. We suggest that using gold as the material, may allow the apparent work function to be reduced to as little as 1 eV, and using calcium may allow an apparent work function as little as 0.2 eV.

In a step 240, a layer of second material 242 is formed on the substantially flat surface 234 of layer 232. Preferably material 242 is silver, but may be any material whose adhesion to material 232 may be carefully controlled. Layer 242 is sufficiently thin that the structure of layer 232 is maintained on its surface. Step 240 is optional, and may be omitted, as is shown In FIG. 3.

In a step 250, a layer of third material 252 is formed on layer 242. Material 232 may be any material in which the Fermi level can be shifted by altering the wave behavior of electrons in a material having a periodic structured surface. Preferably the material is one that, under stable conditions, will not form an oxide layer, or will form an oxide layer of a known and reliable thickness. Preferred materials include, but are not restricted to, metals such as gold and chrome, and materials that under stable conditions form an oxide layer preferably of less than about ten nanometers, and more preferably of less than about five nanometers. We suggest that using gold as the material, may allow the apparent work function to be reduced to as little as 1 eV, and using calcium may allow an apparent work function as little as 0.2 eV. If step 240 has been omitted, as shown in FIG. 3, then conditions used for step 250 are controlled so that adhesion to material 232 may be carefully controlled

In a step 260, a surface of said third material is modified to form a series of indents or channels 254 across said surface. The indents or channels are formed for example and without limitation by any approach conventionally used in microelectronic applications, including stamping, milling, photolithography, e-beam lithography and ion-beam lithography. The dimensions of the indents are chosen to cause wave interference in a material, as disclosed above.

In a step 270, fourth material 272 is formed on the third material in such a way that the indented regions are filled and so that the surface of the layer of a fourth material opposing said indented region 274 is substantially flat. This yields a composite. Preferably material 272 is copper, and is formed by an electrochemical process.

As disclosed above, conditions for forming layers 232, 242 and 252 are carefully chosen so that the adhesion between the layers may be controlled. Where step 240 is omitted, as in FIG. 3, then conditions for forming layers 232 and 252 are carefully chosen so that the adhesion between the layers may be controlled.

The composite formed from the steps above may be mounted in a suitable housing that permits the composite to be opened in a controlled environment. Such a housing is disclosed in WO03/090245, which is incorporated herein by reference in its entirety. The housing may include a getter, either for oxygen or water vapour. The housing may also include positioning means to control the separation of the two parts of the split composite. Preferably the electrodes will be positioned approximately 0.5 μm apart to overcome space charge effects.

The housing may also include thermal pathway elements that allow a heat source to be contacted to one half of the composite, and a heat sink to be contacted to the other. The housing may also include electrical connections to allow a voltage to be applied across the pair of electrodes, or to allow a current flowing between the electrodes to be applied to an external load.

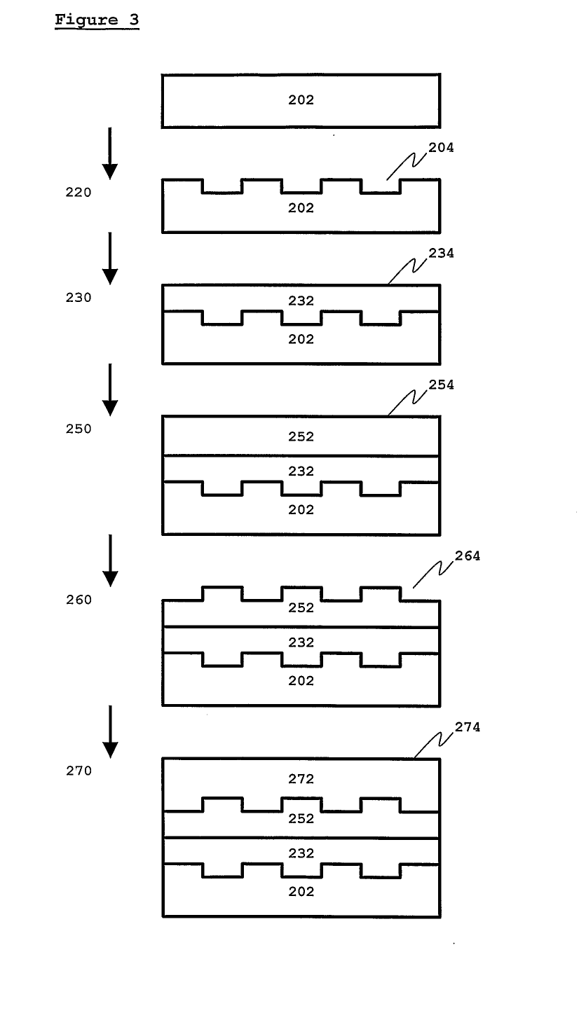

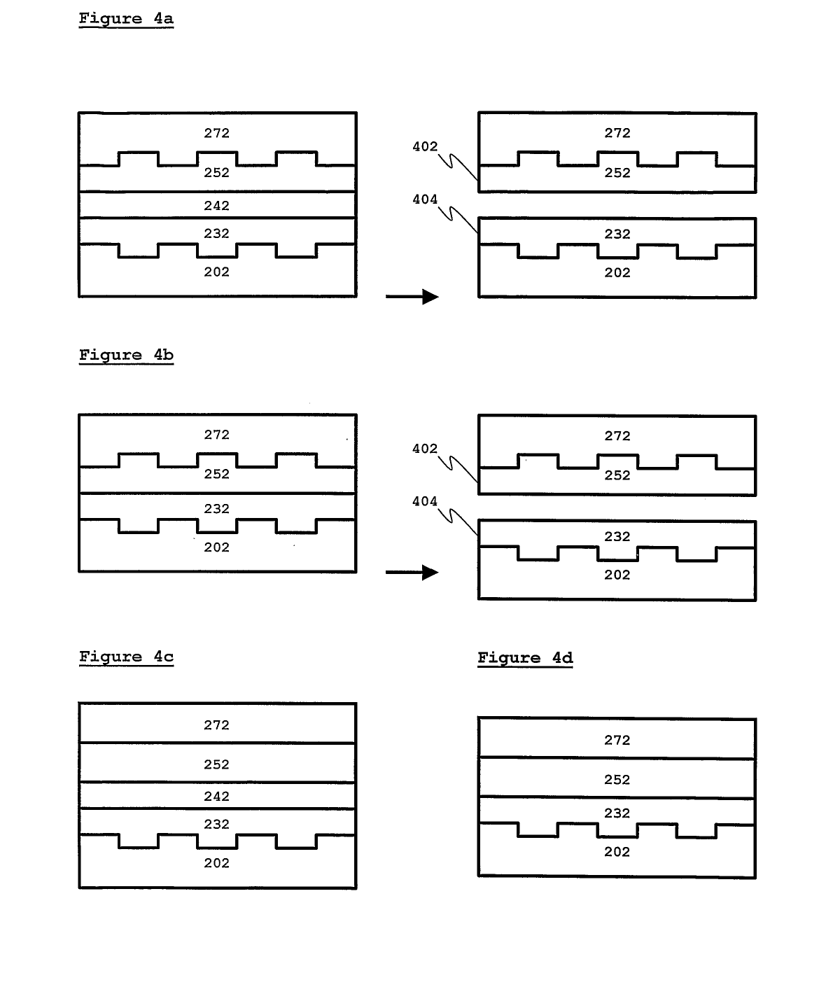

Referring now to FIG. 4a, the composite formed as a result of the process disclosed above and shown in FIG. 2, is separated and layer 242 is removed to yield a pair of electrodes as shown. FIG. 4b illustrates this separation step for a composite formed as a result of the process disclosed above and shown in FIG. 3. The separation may be achieved using any of the methods disclosed in WO03/021663 which is incorporated herein by reference in its entirety, and is preferably a thermal treatment step, which introduces tension sufficiently strong to overcome adhesion between the layers. As a result of this step, any minor imperfections on the surface of electrode 402 are matched on electrode 404.

In a further embodiment, step 260 is omitted, which leads to a composite having only one modified layer, as shown in FIGS. 4c and 4d. When these are separated as described above, one electrode has a surface having an indented under surface, whilst the other electrode is of more conventional construction.

1. A method of fabricating an electrode pair precursor comprising the steps:
(a) providing a substrate;
(b) creating on one surface of said substrate one or more indents of a depth less than approximately 100 nm and a width less than approximately 1 mm;
(c) depositing a first layer forming a substantially plane slab on said substrate and forming a first electrode precursor;
(d) depositing a second layer on said first layer and forming a second electrode precursor;
(e) forming a third layer on said second electrode precursor.

2. The method of claim 1 additionally comprising the step of creating on one surface of said second electrode precursor one or more indents of a depth less than approximately 100 nm and a width less than approximately 1 mm.

3. The method of claim 1 additionally comprising the step of depositing a fourth layer between said first and second layer.

4. The method of claim 3 wherein said fourth layer comprises silver.

5. The method of claim 1 wherein said first layer is substantially homogenous.

6. The method of method of claim 1 wherein said first layer is substantially free of granular irregularities.

7. The method of method of claim 1 wherein said substance is a monocrystal.

8. The method of method of claim 1 wherein said first layer comprises an oxidation-resistant material.

9. The method of method of claim 1 wherein said first layer is selected from the group consisting of: lead, tin, calcium, gold, silica and silicon.

10. The method of method of claim 1 wherein said third layer comprises copper.

11. The method of claim 10 wherein the method for forming said third layer of copper comprises electrolytic growth of copper.

12. The method of method of claim 1 in which said depth is approximately 20 nm.

13. The method of method of claim 1 in which said width is less than approximately 100 nm.

14. The method of method of claim 1 in which walls of said indents are substantially perpendicular to one another.

15. The method of method of claim 1 in which edges of said indents are substantially sharp.

16. An electrode pair precursor, comprising:
(a) a substrate having on one surface one or more indents of a depth less than approximately 100 nm and a width less than approximately 1 mm;
(b) a first layer formed on said surface having one or more indents, said first layer being a first electrode precursor;
(c) a second layer formed on said first layer, said second layer being a second electrode precursor;
(d) a third layer formed on said second electrode precursor

17. The electrode pair precursor of claim 16 wherein said second electrode precursor has one or more indents of a depth less than approximately 100 nm and a width less than approximately 1 mm.

18. The electrode pair precursor of claim 16 additionally comprising a fourth layer deposited between said first and second layer.

19. The electrode pair precursor of claim 18 wherein said fourth layer comprises silver.

20. The electrode pair precursor of claim 16 wherein said first layer is substantially homogenous.

21. The electrode pair precursor of claim 16 wherein said first layer is substantially free of granular irregularities.

22. The electrode pair precursor of claim 16 wherein said substance is a monocrystal.

23. The electrode pair precursor of claim 16 wherein said first layer comprises an oxidation-resistant material.

24. The electrode pair precursor of claim 16 wherein said first layer is selected from the group consisting of: lead, tin, calcium, gold, silica and silicon.

25. The electrode pair precursor of claim 16 wherein said third layer comprises copper.

26. The electrode pair precursor of claim 16 in which said depth is approximately 20 nm.

27. The electrode pair precursor of claim 16 in which said width is less than approximately 100 nm.

28. The electrode pair precursor of claim 16 in which walls of said indents are substantially perpendicular to one another.

29. The electrode pair precursor of claim 16 in which edges of said indents are substantially sharp.
